(19) United States
(12) Patent Application Publication
(10) Pub. No.: US 2013/0217381 A1
(43) Pub. Date: Aug. 22, 2013

(54) BROADCASTING SHARED NETWORK INFORMATION

(71) Applicant: Qualcomm Incorporated, (US)

(72) Inventors: Mungal Singh Dhanda, Farnborough (GB); Philip J. Children, Farnborough (GB)

(73) Assignee: Qualcomm Incorporated, San Diego, CA (US)

(21) Appl. No.: 13/654,654

(22) Filed: Oct. 18, 2012

Related U.S. Application Data
(60) Provisional application No. 61/600,791, filed on Feb. 20, 2012.
(60) Provisional application No. 61/601,792, filed on Feb. 22, 2012.

(51) Int. Cl. H04W 4/06

(52) U.S. Cl. 455/422.1

(57) ABSTRACT

Devices, systems, articles of manufacture, and methods for broadcasting information related to multiple core networks using a single access network are described. According to some embodiments, information to be broadcast corresponding to the multiple core networks is obtained. A single system information (SI) message is generated based on the obtained information. The single system information (SI) message is broadcast to a wireless communication device. Other aspects, embodiments, and features are also claimed and described.

### RELATED APPLICATIONS AND PRIORITY CLAIMS

This application is related to and claims priority from U.S. Provisional Patent Application Ser. No. 61/600,791, filed Feb. 20, 2012, for “Broadcasting Shared Network Information,” and from U.S. Provisional Patent Application Ser. No. 61/601,792, filed Feb. 22, 2012, for “Broadcasting Core Network Sharing Information,” both of said application are expressly hereby incorporated herein by reference in their entireties as if fully set forth below and for all applicable purposes.

### TECHNICAL FIELD

The present disclosure relates generally to communication systems. More specifically, the present disclosure relates to systems and methods for broadcasting shared network information.

### BACKGROUND

Wireless communication systems have become an important means by which many people worldwide have come to communicate. A wireless communication system may provide communication for a number of subscriber stations, each of which may be serviced by a base station.

Generally, base stations may transmit information needed by subscriber stations to perform wireless communications. This information may have a limited number of bits. If the base station needs to transmit more information than can be transmitted in a single system information (SI) message, either two system information (SI) messages may be transmitted (resulting in delay and increased power consumption) or a single system information (SI) message may be transmitted with less data. One configuration where a base station may need to transmit additional information is when multiple core networks share a single access network. Given that wireless network traffic continues to grow there are desires to enable additional traffic in efficient manners while also being mindful of power consumption.

### SUMMARY OF SOME EXAMPLE EMBODIMENTS

Devices, systems, articles of manufacture, and methods for broadcasting information related to multiple core networks using a single access network are described. Below aspects and embodiments of the present invention a summarized for the reader's benefit. These summaries in no way limit the full breadth of the technology claimed below in this application.

According to some embodiments, information to be broadcast corresponding to the multiple core networks is obtained. A single system information (SI) message is generated based on obtained information. The single system information (SI) message is broadcast to a wireless communication device.

According to some embodiments, methods may be performed by a base station. The obtained information may correspond to a public land mobile network. The obtained information may include a mobile network code, a mobile country code, an access class code, and a network color code. The length of the mobile country code field may be 10 bits. The length of the mobile network code field may be 10 bits. The mobile country code field may be coded as a binary value of the mobile country code, and the mobile network code field may be coded as a binary value of the mobile network code.

The length of the access class code field may be 12 bits. 10 bits of the access class code may represent normal classes. 2 bits of the access class code may represent special classes. The value of the 2 bits of the access class code may represent different set of special classes. The length of the network color code field may be 4 bits.

Network color code information may be transmitted for only four base station identity codes. A skip indicator may be used to indicate which set of four base station identity codes may be used. The skip indicator may indicate an offset applied to the set of four base station identity codes. The set of four base station identity codes may be a set of four contiguous base station identity codes.

According to another embodiment, a method for receiving information related to multiple core networks that use a single access network is described. A single system information message that comprises information for multiple core networks that use the single access network is received. Network identities, permitted access classes, and neighbor cell information for the multiple core networks are determined from the single system information message. The network identities, permitted access classes, and neighbor cell information to wireless communications are applied.

The method may be performed by a wireless communication device. The obtained information may correspond to a public land mobile network, and the obtained information may include a mobile network code, a mobile country code, an access class code, and a network color code. The length of the mobile country code field may be 10 bits, and the length of the mobile network code field may be 10 bits.

The mobile country code field may be coded as a binary value of the mobile country code, and the mobile network code field may be coded as a binary value of the mobile network code. The length of the access class code field may be 12 bits. 10 bits of the access class code may represent normal classes. 2 bits of the access class code represents special classes. The value of the 2 bits of the access class code may represent different set of special classes.

The length of the network color code field may be 4 bits. Network color code information may be transmitted for only four base station identity codes. A skip indicator may be used to indicate which set of four base station identity codes may be used. The skip indicator may indicate an offset applied to the set of four base station identity codes. The set of four base station identity codes may be a set of four contiguous base station identity codes.

An additional system information message may also be received. A portion of the network identities, the permitted access classes, and the neighbor cell information for the multiple core networks may be determined from the single system information message and a portion of the network identities, the permitted access classes, and the neighbor cell information for the multiple core networks may be determined from the additional system information message. The single system information message may be a new system information message, and the system information message may be a legacy system information message. The single system information message may include information corresponding to four multiple core networks.

According to some embodiments, an apparatus for broadcasting information related to multiple core networks that use a single access network are described. The apparatus includes a processor and executable instructions stored in memory in electronic coupled to the processor. The apparatus obtains information to be broadcast corresponding to the multiple core networks. The apparatus also generates a single system information message based on the obtained information. The apparatus further broadcasts single system information message to a wireless communication device.

According to another embodiment, an apparatus for receiving information related to multiple core networks that use a single access network is described. The apparatus includes a processor and executable instructions stored in memory that is in electronic communication with the processor. The apparatus receives a single system information message that comprises information for multiple core networks that use the single access network. The apparatus also determines network identities, permitted access classes, and neighbor cell information for the multiple core networks from the single system information message. The apparatus further applies the network identities, permitted access classes, and neighbor cell information to wireless communications.

According to yet another embodiment, a computer-program product for broadcasting information related to multiple core networks that use a single access network is described. The computer-program product includes a non-transitory computer-readable medium with instructions thereon. The computer-program product includes instructions for causing a base station to obtain information to be broadcast corresponding to the multiple core networks. The computer-program product also includes instructions for causing the base station to generate a single system information message based on the obtained information. The computer-program product further includes instructions for causing the base station to broadcast the single system information message to a wireless communication device.

According to still another embodiment, a computer-program product for receiving information related to multiple core networks that use a single access network is described. The computer-program product includes a non-transitory computer-readable medium with instructions thereon. The computer-program product includes instructions for causing a wireless communication device to receive a single system information message that comprises information for multiple core networks that use the single access network. The computer-program product also includes instructions for causing the wireless communication device to determine network identities, permitted access classes, and neighbor cell information for the multiple core networks from the single system information message. The computer-program product further includes instructions for causing the wireless communication device to determine network identities, permitted access classes, and neighbor cell information for the multiple core networks from the single system information message.

According to still yet another embodiment, an apparatus configured for broadcasting information related to multiple core networks that use a single access network is described. The apparatus includes means for obtaining information to be broadcast corresponding to the multiple core networks. The apparatus also includes means for generating a single system information message based on the obtained information. The apparatus further includes means for broadcasting the single system information message to a wireless communication device.

According to still yet another embodiment, an apparatus configured for receiving information related to multiple core networks that uses a single access network is described. The apparatus includes means for receiving a single system information message that comprises information for multiple core networks that use the single access network. The apparatus also includes means for determining network identities, permitted access classes, and neighbor cell information for the multiple core networks from the single system information message. The apparatus further includes means for applying the network identities, permitted access classes, and neighbor cell information to wireless communications.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments, it should be understood that such exemplary embodiments can be implemented in various devices, systems, and methods.

### BRIEF DESCRIPTION OF THE DRAWINGS

FIG. 1 shows an example of a wireless communication system in which the systems and methods disclosed herein may be utilized according to some embodiments;

FIG. 2 is a block diagram illustrating one configuration of a wireless communication system configured for broadcasting information related to additional multiple core networks using a single access network according to some embodiments;

FIG. 3 is a block diagram illustrating one configuration of sending core network information from a core network to an access network according to some embodiments;

FIG. 4 is a block diagram illustrating a single access network broadcasting a system information (SI) message related to multiple additional core networks to multiple wireless communication devices according to some embodiments;

FIG. 5 is a block diagram illustrating the transmission of a system information (SI) message from an access network to a wireless communication device according to some embodiments of the present invention;

FIG. 6 is a block diagram illustrating the structure of a single system information message (SI) according to some embodiments of the present invention;

FIG. 7 is a flow diagram of a method for broadcasting additional information related to multiple additional core networks using a single access network according to some embodiments of the present invention;

FIG. 8 is a flow diagram of a more detailed method for broadcasting additional information related to multiple additional core networks using a single access network according to some embodiments of the present invention;

FIG. 9 is a flow diagram of a method for receiving information related to multiple additional core networks using a single access network according to some embodiments of the present invention;

FIG. 10 is a flow diagram of a more detailed method for receiving information related to multiple additional core networks using a single access network according to some embodiments of the present invention;

FIG. 11 shows an example of a wireless communication system in which the systems and methods disclosed herein may be utilized;

FIG. 12 shows a block diagram of a transmitter and a receiver in a wireless communication system;

FIG. 13 illustrates certain components that may be included within a base station according to some embodiments of the present invention; and

FIG. 14 illustrates certain components that may be included within a wireless communication device according to some embodiments of the present invention.

### DETAILED DESCRIPTION

The Global System for Mobile Communications (GSM) is a widespread standard in cellular, wireless communication. GSM is relatively efficient for standard voice services. However, high-fidelity audio and data services require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations (the Ater and Abis interfaces) and the base station controllers (A interfaces, etc.). GERAN represents the core of a GSM network. It routes phone calls and packet data to and from the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, for uplink communication, GSM-900 commonly uses a radio spectrum in the 890-915 megahertz (MHz) bands (Mobile Station to Base Transceiver Station). For downlink communication, GSM 900 uses 935-960 MHz bands (base station 102 to wireless communication device 104). Furthermore, each frequency band is divided into 200 kHz carrier frequencies providing 124 radio frequency (RF) channels spaced at 200 kHz. GSM-1900 uses the 1850-1910 MHz bands for the uplink and 1930-1990 MHz bands for the downlink. Like GSM 900, FDMA divides the spectrum for both uplink and downlink into 200 kHz-wide carrier frequencies. Similarly, GSM-850 uses the 824-849 MHz bands for the uplink and 869-894 MHz bands for the downlink, while GSM-1800 uses the 1710-1785 MHz bands for the uplink and 1805-1880 MHz bands for the downlink.

Each channel in GSM is identified by a specific absolute radio frequency channel (ARFCN). For example, ARFCN 1-124 are assigned to the channels of GSM 900, while ARFCN 512-810 are assigned to the channels of GSM 1900. Similarly, ARFCN 128-251 are assigned to the channels of GSM 850, while ARFCN 512-885 are assigned to the channels of GSM 1800.

Furthermore, each base station may be assigned one or more carrier frequencies. Each carrier frequency is divided into eight time slots using TDMA such that eight consecutive time slots form one TDMA frame with a duration of 4.615 milliseconds (ms). A physical channel occupies one time slot within a TDMA frame. Each active wireless communication device or user is assigned one or more time slot indices for the duration of a call. User-specific data for each wireless communication device is sent in the time slot(s) assigned to that wireless communication device and in TDMA frames used for the traffic channels.

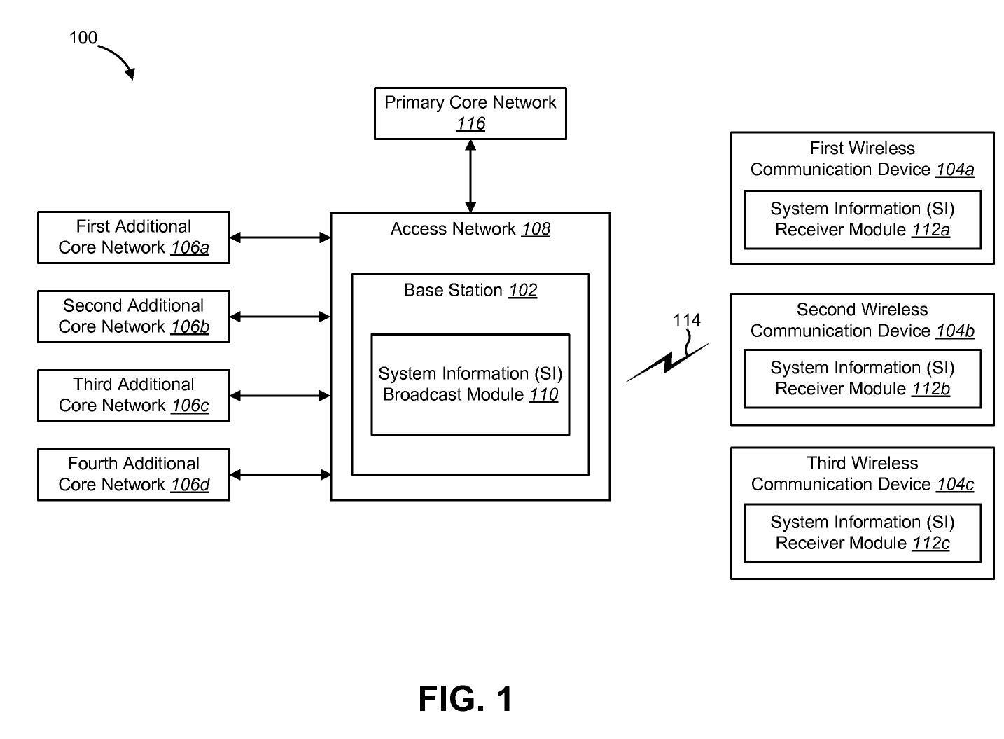

FIG. 1 shows a wireless communication system 100 in which the systems and methods disclosed herein may be utilized. The wireless communication system 100 may include a primary core network 116, multiple additional core networks 106a-d, and multiple wireless communication devices 104a-c. The primary core network 116 and the multiple additional core networks 106a-d may communicate with the multiple wireless communication devices 104a-c through a single access network 108. For example, the access network 108 may send transmissions on a broadcast channel 114 to the wireless communication devices 104a-c.

As used herein, the term “wireless communication device” refers to an electronic device that may be used for voice and/or data communication over a wireless communication system. Examples of wireless communication devices 104 include cellular phones, personal digital assistants (PDAs), handheld devices, wireless modems, laptop computers, personal computers, machine type communication (MTC) devices, machine-to-machine (M2M) devices and sensor devices (including, for example, so-called “smart-meters,” alarms and health monitoring devices). A wireless communication device 104 may alternatively be referred to as an access terminal, a mobile terminal, a mobile station, a remote station, a user terminal, a terminal, a subscriber unit, a subscriber station, a mobile device, a wireless device, user equipment (UE), an MTC device or an M2M device, or some other similar terminology.

The primary core network 116 and each additional core network 106a-d may be coupled to the access network 108. For example, the primary core network 116 and the additional core networks 106 may be coupled to the access network 108 via a backhaul. This connection may be wired or wireless. The primary core network 116 and each additional core network 106a-d may provide services and may facilitate the exchange of information to customers belonging to that additional core network 106.

The access network 108 may include a base station 102 and a system information (SI) broadcast module 110. The access network 108 may facilitate communications between the core networks (e.g., primary core network 116 and additional core networks 106) and the wireless communication devices 104. For example, the access network 108 may be a radio access network (RAN).

In some configurations, the access network 108 may include multiple base stations (not shown) to broadcast messages to the multiple wireless communication devices 104a-c. For example, the access network 108 may send downlink communications to the wireless communication devices 104a-c and receive uplink communications from the wireless communication devices 104a-c.

As used herein, the term “base station” refers to a wireless communication station that is used to communicate with wireless communication devices 104. A base station 102 may alternatively be referred to as an access point (including nano-, pico- and femto-cells), a Node B, an evolved Node B, a Home Node B, or some other similar terminology.

The system information (SI) broadcast module 110 may be included on a base station 102 and may broadcast system information (SI) messages to the wireless communication devices 104 (i.e., a single system information (SI) message may be sent to multiple wireless communication devices 104 over a single broadcast channel 114).

The system information (SI) broadcast module 110 may broadcast information corresponding to the primary core network 116 in a system information (SI) type 3 message. The system information (SI) broadcast module 110 may also broadcast a new single system information (SI) message on the broadcast channel 114, which includes information from the additional core networks 106a-d. In other words, this new single system information (SI) message may include a combination of system information (SI) data from a plurality of additional core networks 106. The new single system information (SI) message may be a system information (SI) type 22 message. The single system information (SI) message may be received by each wireless communication device 104a-c. In other words, the single system information (SI) message may be broadcast simultaneously, or individually, to each wireless communication device 104.

Each wireless communication device 104a-c may include its own system information (SI) receiver module 112a-c, respectively. The system information (SI) receiver module 112 may receive the system information (SI) message broadcast by the access network 108. As discussed above, the system information (SI) message may include information corresponding to the various additional core networks 106a-d.

Typically, the system information (SI) message includes information necessary for a wireless communication device 104 to connect to an additional core network 106. For example, for each additional core network 106, a system information (SI) message may include the network identity (i.e., a public land mobile network (PLMN) ID), the permitted access classes (i.e., which subscriber classes can access the network) and neighbor cell information.

When one or more additional core networks 106a-d share the single access network 108 with the primary core network 116, each additional core network 106a-d must be able to broadcast its information to the wireless communication devices 104a-c. In other words, the inclusion of information corresponding to one or more additional core networks 106 in a system information (SI) message necessitates the transmission of additional core network 106 information. For example, this additional information includes the network identities for the additional core networks 106a-d sharing the access network 108, the permitted access classes for each additional core network 106a-d and the neighbor cell information to allow mobility between shared and non-shared cells corresponding to each additional core network 106a-d.

In previous proposals, system information (SI) message type 16 and 17 were used to broadcast the additional information. However, in those proposals, two or more system information (SI) messages were required to be received and processed by the wireless communication device 104 before acquiring all of the additional PLMNs. Furthermore, under previous proposals, the use of the Support of Localized Service Area (SoLSA) feature was prevented when four additional PLMNs were broadcast.

Under the embodiments of the present invention described herein, a new single system information (SI) message may be defined that is designed to carry information for up to four additional PLMNs (corresponding to the additional core networks 106a-d). The new system information (SI) message may be a type 22 message.

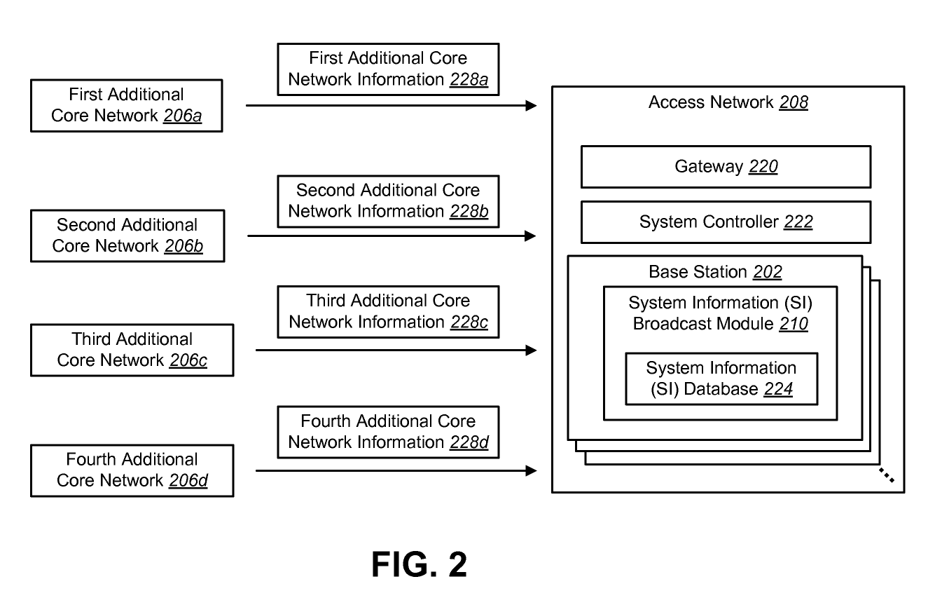

FIG. 2 is a block diagram illustrating one configuration of a wireless communication system configured for broadcasting information related to additional multiple core networks 206 using a single access network 208. The wireless communication system may include a first additional core network 206a, a second additional core network 206b, a third additional core network 206c, a fourth additional core network 206d, and an access network 208. The additional core networks 206a-d and the access network 208 of FIG. 2 may be one configuration of the additional core networks 106a-d and the access network 108 described in connection with FIG. 1.

Each additional core network 206a-d may send additional core network information 228a-d to the access network 208. For example, the second additional core network 206b may send second additional core network information 228b to the access network 208. Additional core network information 228 may include PLMN data, such as PLMN IDs, permitted access classes, and neighbor cell information. Each additional core network 206a-d may send the additional core network information 228 via a backhaul link or other link established between the additional core network 206a-d and the access network 208. The connection between each additional core network 206 and the access network 208 may be wired or wireless.

The access network 208 may include a gateway 220, a system controller 222, and a base station 202. The gateway 220 and/or the system controller 222 may be part of, or separate from, the base station 202. For example, the system controller 222 may be physically located inside the base station 202. In some configurations, the access network 208 may include a plurality of base stations 202. The system controller 222 may include a mobile switching center (MSC) (not shown) and a serving GPRS support node (SGSN) (not shown).

The base station 202 may include a system information (SI) broadcast module 210. The system information (SI) broadcast module 210 may facilitate the broadcasting of system information (SI) messages to the wireless communication devices 104.

The system information (SI) broadcast module 210 may include a system information (SI) database 224. The system information (SI) database 224 may record and store information received from each of the additional core networks 206a-d. For instance, the system information (SI) database 224 may include data received from each additional core network information 228 message. The information may be stored in raw and/or processed form. For example, the system information (SI) broadcast module 210 may receive each additional core network information 228 message and may process all the additional core information 228a-d messages before storing the processed information in the system information (SI) database 224. In some configurations, the system information (SI) database 224 may be part of the base station 202 or may be located elsewhere in the access network 208.

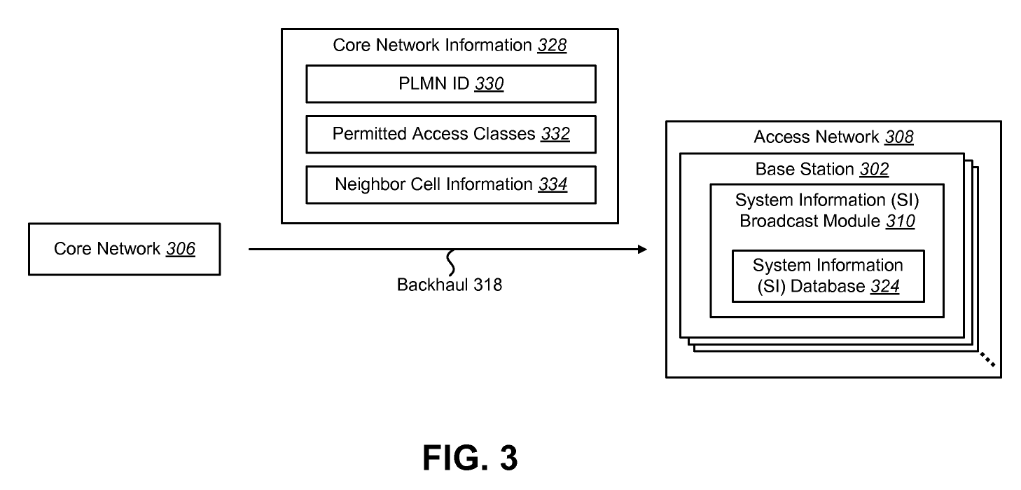

FIG. 3 is a block diagram illustrating one configuration of sending core network information 328 from a core network 306 to an access network 308. The core network 306 and the access network 308 in FIG. 3 may be one configuration of the additional core network 106 and the access network 108 described in connection with FIG. 1. In another configuration, the core network 306 in FIG. 3 may correspond to the primary core network 116 described in connection with FIG. 1.

The core network 306 may send core network information 328 to the access network 308 via a backhaul 318 or other similar infrastructure. The core network information 328 may correspond to the primary core network 116 or one of the additional core networks 106a-d. In the case of multiple additional core networks 106a-d, each core network 306 may send core network information 328 corresponding to that core network 306. The core network information 328 may correspond to an available public land mobile network (PLMN) (e.g., the primary core network 116 or one of the additional core networks 106a-d).

The core network information 328 may include network identities (e.g., PLMN IDs) 330, permitted access classes 332, and neighbor cell information 334. A PLMN ID 330 may identify a core network 306 that is available to provide services for a corresponding wireless communication device 104. For example, the PLMN ID 330 may identify a network identity operating via the access network 308.

The permitted access classes 332 may indicate which subscriber classes can access the core network 306 (via the access network 308) and which subscriber classes may be barred. For example, certain classes, such as emergency workers, may be permitted to have access to services, such as making a call during an emergency, while other classes, such as the general public, may be barred from making calls during the emergency.

The neighbor cell information 334 may indicate core networks 106a-d that are available via the access network 308. For example, the neighbor cell information 334 may indicate that specific cells in the access network 308 have available services from a plurality of additional core networks 106a-d while other cells on the access network 308 are limited to services from only the primary core network 116.

The access network 308 may include a base station 302. The base station 302 may include a system information (SI) broadcast module 310 having a system information (SI) database 324. The system information (SI) database 324 may store the PLMN IDs 330, the permitted access classes 332, and the neighbor cell information 334 received from the core network 306.

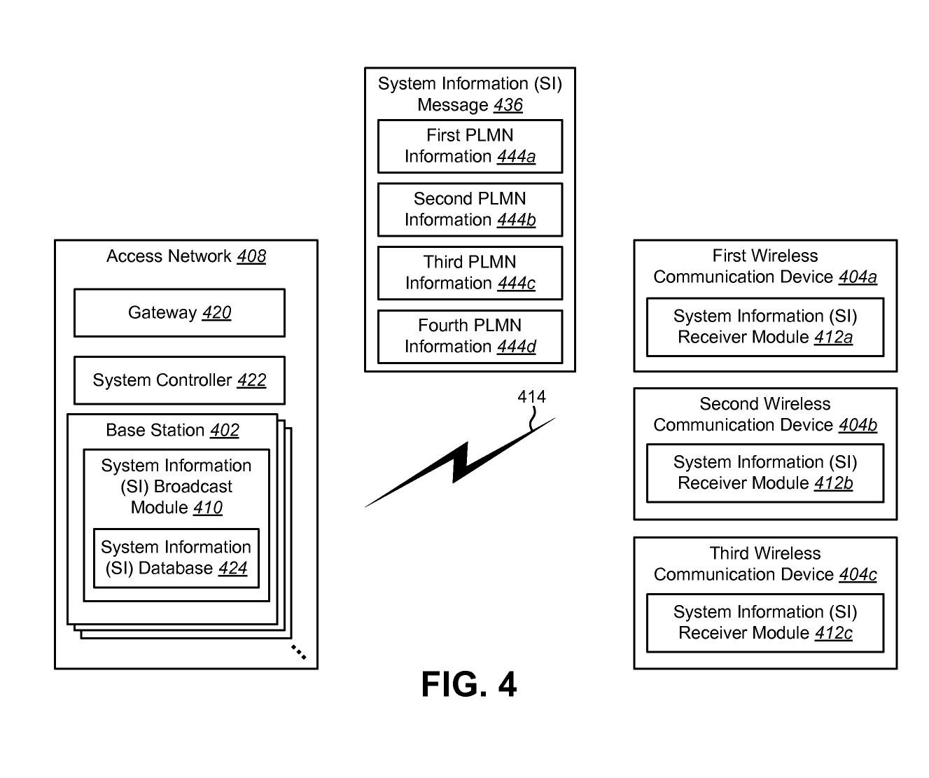

FIG. 4 is a block diagram illustrating a single access network 408 broadcasting a system information (SI) message 436 related to multiple additional core networks 106 to multiple wireless communication devices 404a-c. The wireless communication devices 404a-c and the access network 408 of FIG. 4 may be one configuration of the wireless communication devices 104a-c and the access network 108 described in connection with FIG. 1.

The access network may include a gateway 420, a system controller 422, and a base station 402. The gateway 420 and/or the system controller 422 may be located in the base station 402 or may be located elsewhere in the access network 408. It should be appreciated that multiple base stations 402 may be located within the single access network 408.

The base station 402 may include a system information (SI) broadcast module 410. The system information (SI) broadcast module 410 may facilitate the broadcasting of system information (SI) messages 436 to the wireless communication devices 404a-c. For example, the base station 402 may broadcast a single system information (SI) message 436 to the first wireless communication device 404a, the second wireless communication device 404b, and the third wireless communication device 404c via a broadcast channel 414. The single system information (SI) message 436 may be broadcast simultaneously, or individually, to each wireless communication device 404.

The system information (SI) message 436 may include system information corresponding to each of the additional core networks 106a-d. In some embodiments, the system information (SI) message 436 may be a new system information (SI) message, such as a system information (SI) type 22 message.

The information included in a system information (SI) message 436 may be received from the additional core networks 106a-d by the access network 408. The access network 408 may process and combine the core network information 328 received from each additional core network 106a-d. For example, the base station 402 or the system controller 422 may repackage the core network information 328 received from each of the additional core networks 106a-d into a single system information (SI) message 436. The access network 408 may store the core network information 328 received from each additional core network 106a-d in the system information (SI) database 424.

The system information (SI) message 436 may be broadcast to all the wireless communication devices 404 within range of the access network 408, may be sent to a sub-set of the wireless communication devices 404, or may be sent to a single wireless communication device 404. The system information (SI) message 436 may include a first PLMN information 444a, a second PLMN information 444b, a third PLMN information 444c, and a fourth PLMN information 444d. Each piece of PLMN information 444 may include a PLMN ID 330 (of the additional core network 106), permitted access classes 332, and neighbor cell information 334 corresponding to an additional core network 106. In this manner, the system information (SI) message 436 may include information corresponding to the multiple additional core networks 106a-d.

In one configuration, the base station 402 may broadcast the system information (SI) message 436 to the wireless communication devices 404 via the broadcast channel 414. A wireless communication device 404 may receive the system information (SI) message 436 via a system information (SI) receiver module 412a-c. Upon receiving the system information (SI) message 436, a wireless communication device 404 may process and apply the system information (SI) message 436. As an example, the first wireless communication device 404a may receive the system information (SI) message 436. Included in the system information (SI) message 436 may be a PLMN ID 330, permitted access classes 332, and neighbor cell information 334 corresponding to the first additional network core 106a. Based on this obtained information, the first wireless communication device 404a may then be able to connect to, and communicate with, the first additional network core 106a via the access network 408.

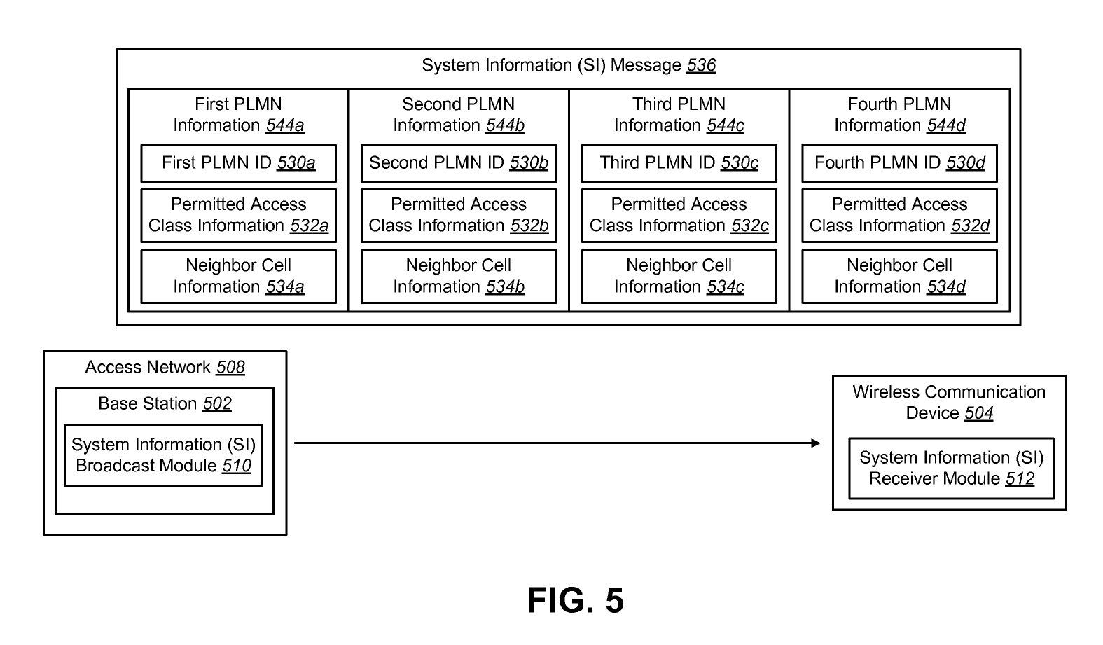

FIG. 5 is a block diagram illustrating the transmission of a system information (SI) message 536 from an access network 508 to a wireless communication device 504 according to some embodiments of the present invention. The access network 508 and the wireless communication device 504 in FIG. 5 may be one configuration of the access network 108 and the wireless communication device 104 described in connection with FIG. 1.

A new single system information (SI) message 536 may be sent from the access network 508 to the wireless communication device 504. A base station 502 in the access network 508 may use the system information (SI) broadcast module 510 to transmit the system information (SI) message 536 to the wireless communication device 504. The wireless communication device 504 may receive the system information (SI) message 536 by way of a system information (SI) receiver module 512 located on the wireless communication device 504.

The system information (SI) message 536 may include information (i.e., PLMN information 544) received from the multiple additional core networks 106a-d. For example, a first PLMN information 544a, which may include a first PLMN ID 530a, permitted access class information 532a, and neighbor cell information 534a, may correspond to the first additional core network 106a. Similarly, a second PLMN information 544b, which may include a second PLMN ID 530b, permitted access class information 532b, and neighbor cell information 534b, may correspond to the second additional core network 106b. A third PLMN information 544c, which may include a third PLMN ID 530c, permitted access class information 532c, and neighbor cell information 534c, may correspond to the third additional core network 106c. Likewise, a fourth PLMN information 544d, which may include a fourth PLMN ID 530d, permitted access class information 532d, and neighbor cell information 534d, may correspond to the fourth additional core network 106d.

By sending the system information (SI) message 536, additional core network information 228 may be sent to the wireless communication device 504 via a single system information (SI) message 536 (as opposed to multiple system information (SI) messages 536). The single system information (SI) message 536 may include information for the wireless communication device 504 corresponding to one or more additional core networks 106a-d sharing the same access network 508.

Sending PLMN information 544 corresponding to the additional core networks 106 in a single system information (SI) message 536 has many benefits over known approaches. For example, the wireless communication device 504 may receive all necessary information in one system information (SI) message 536 (and thus does not have to wait for subsequent system information (SI) messages from the base station 502 to obtain necessary information regarding additional PLMNs). This allows the wireless communication device 504 to reduce power consumption because the wireless communication device 504 does not need to wait for subsequent system information (SI) messages 536.

Another benefit is that the delay to cell reselection is reduced. Cell reselection delay is reduced because the wireless communication device 504 does not have to wait for two or more system information (SI) messages 536 before determining which services on which additional core networks 106 are available in which cells. Further, another benefit gained from embodiments of the present invention is that no restrictions are imposed on using Support of Localized Service Area (SoLSA) features.

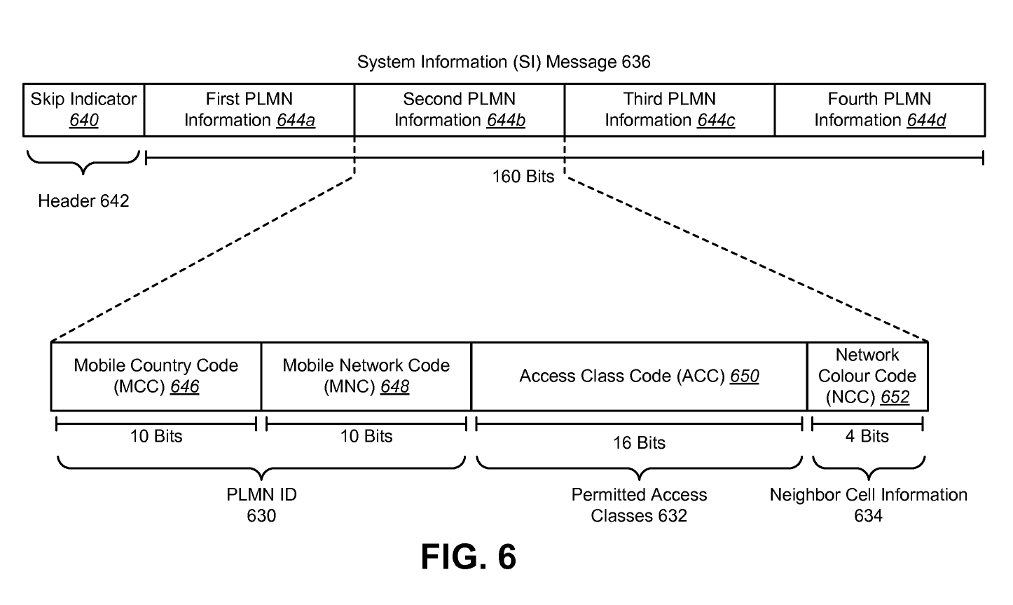

FIG. 6 is a block diagram illustrating the structure of a single system information message (SI) 636 according to some embodiments of the present invention.

The single system information (SI) message 636 may be broadcast from an access network 108 to one or more wireless communication devices 104. The system information message (SI) 636 may include a header 642. The header may include a skip indicator 640. The header may also include other information elements (not shown).

The system information message (SI) 636 may include data from up to four additional core networks 106a-d, each stored as information corresponding to an additional PLMN (i.e., PLMN information 644a-d). For example, the system information (SI) message 636 may include a first PLMN information 644a, a second PLMN information 644b, a third PLMN information 644c, and a fourth PLMN information 644d. The system information (SI) message 636 may include up to 160 bits for the PLMN information 644, with each PLMN information 644 segment including up to 40 bits.

The additional information that needs to be broadcast in the system information (SI) message 636 may include the mobile country code (MCC) 646 and the mobile network code (MNC) 648, the access class code (ACC) 650, and the network color code (NCC) 652 for each PLMN.

Under legacy approaches, the mobile country code (MCC) 646 is 12 bits in length, the mobile network code (MNC) 648 is 12 bits in length, the access class code (ACC) 650 is 16 bits in length, and the network color code (NCC) 652 is 8 bits in length. Thus, each segment of PLMN information 644 requires 48 bits under current legacy approaches.

Under this legacy approach, if four additional core networks 106 use a single access network 108, the total additional information required in a system information (SI) message 636 (for the four additional core networks 106) would be 192 bits. This is problematic under current 3GPP GERAN standards because system information (SI) messages 636 are limited to 160 bits in length. Thus, to transmit 192 bits, multiple system information (SI) messages 636 would be required.

In contrast to the legacy approach, under the embodiments of the present invention described herein, each segment of PLMN information 644 may only require 40 bits in length. Thus, the single system information message (SI) 636 including information corresponding to four additional PLMNs may be 160 bits in length.

As shown in FIG. 6, the mobile country code (MCC) 646 and mobile network code (MNC) 648 may each be 10 bits long. The mobile country code (MCC) 646 and mobile network code (MNC) 648 may correspond to a PLMN ID 630 of an additional core network 106. The access class code (ACC) 650 may be 16 bits in length and may correspond to permitted access classes 632 of an additional core network 106. The network color code (NCC) 652 may be 4 bits and may correspond to neighbor cell information 634 of an additional core network 106. Thus, according to some embodiments of the present invention, each segment of additional PLMN information 644 requires only 40 bits. Therefore, information corresponding to four additional core networks 106a-d may be sent in a single system information (SI) message 636. Table 1 below provides the bits syntax for sharing information for a segment of additional PLMN information 644 on a single access network 108.

TABLE 1

```
< Sharing PLMN Information > ::=
    < MCC : bit (10) >
    < MNC : bit (10) >
    < ACC : bit (16) >
    < NCC : bit (4) >
    < spare padding > ;
```

In some configurations, the system information (SI) message 636 may be a new system information (SI) type 22 message. Details for the new system information (SI) type 22 message are provided in Table 2 below according to one configuration. The new system information (SI) type 22 message may be designed to carry information for up to four additional PLMNs.

TABLE 2

| | | | | | Length |
|---|---|---|---|---|---|
| IEI | Information Element | Type/Reference | Presence | Format | (bytes) |
| | L2 Pseudo Length | L2 Pseudo | M | V | 1 |
| | | Length | | | |
| | | 10.5.2.19 | | | |
| | RR management | Protocol | M | V | ½ |
| | Protocol | Discriminator | | | |
| | Discriminator | 10.2 | | | |
| | Skip Indicator | Skip Indicator | M | V | ½ |
| | | 10.3.1 | | | |
| | system information | Message Type | M | V | 1 |
| | Type 22 | 10.4 | | | |
| | Message Type | | | | |
| | Sharing PLMN 1 | Sharing PLMN | M | V | 5 |
| | | Information | | | |
| | Sharing PLMN 2 | Sharing PLMN | M | V | 5 |
| | | Information | | | |
| | Sharing PLMN 3 | Sharing PLMN | M | V | 5 |
| | | Information | | | |
| | Sharing PLMN 4 | Sharing PLMN | M | V | 5 |
| | | Information | | | |

As described previously, each additional PLMN may be reconfigured to require fewer bits. For example, under previous approaches, the mobile country code (MCC) 646 and mobile network code (MNC) 648 each required 12 bits, while under some embodiments of the present invention, the mobile country code (MCC) 646 and mobile network code (MNC) 648 may each only require 10 bits.

The mobile country code (MCC) 646 field has a range from 000 to 999. The mobile country code (MCC) 646 is currently coded in 3GPP specifications as binary coded decimal (BCD), which requires 4 bits for each digit. Because the mobile country code (MCC) 646 has a valid range of 000 to 999, 12 bits are typically required for the mobile country code (MCC) 646. However, because there are only 1000 valid mobile country code (MCC) 646 values, only 10 bits are needed for the mobile country code (MCC) 646. 10 bits may provide up to 1024 combinations (or code points). The first 1000 combinations (or code points) may represent the mobile country code (MCC) 646 from 000 to 999 by using only 10 bits. The remaining code points may be treated as FFF (i.e., the remaining code points are treated as invalid PLMN IDs 330).

Similarly, the mobile network code (MNC) 648 field has a valid range from 000 to 999 and is also coded as binary coded decimal (BCD). Thus, the mobile network code (MNC) 648 field currently uses 12 bits while only 10 bits are required. Like the mobile country code (MCC) 646, code combinations or code points may be applied to the mobile network code (MNC) 648 field not in binary coded decimal (BCD). In other words, the first 1000 combinations (or code points) may represent the mobile network code (MNC) 648 from 000 to 999 by using only 10 bits. The remaining code points may be treated as FFF (i.e., the remaining code points are treated as invalid public land mobile network (PLMN) identities).

By using only 10 bits for the mobile country code (MCC) 646 and 10 bits for the mobile network code (MNC) 648 field, 4 bits per segment of additional PLMN information 644 may be saved. Thus, if there are four segments of additional PLMN information 644, 16 bits may be saved. The code points and their corresponding values for the mobile country code (MCC) 646 or the mobile network code (MNC) 648 are given in Table 3 below.

TABLE 3

| | Mobile Country Code Value/ |
|---|---|
| Code Point | Mobile Network Code Value |
| 0000000000 | 000 |
| 0000000001 | 001 |
| — | — |
| 1111100110 | 998 |
| 1111100111 | 999 |
| 1111101000 | FFF |

Table 3 shows mobile country code (MCC) 646 and mobile network code (MNC) 648 code points for values 000-999. All other mobile country code (MCC) 646 and mobile network code (MNC) 648 values (e.g., values 1000-1024) may be reserved. For example, all values from 1000-1024, inclusive, may be treated as a 1111110000 code point or an FFF value. If the value is FFF, then the entire sharing PLMN information element may be ignored.

As shown in Table 3, the mobile country code (MCC) 646 field may be coded as a binary value rather than as a binary coded decimal (BCD). Similarly, the mobile network code (MNC) 648 field may be coded as a binary value rather than as a binary coded decimal (BCD).

In the present 3GPP GERAN specification, the access class code (ACC) 650 field is defined to be 16 bits. (See 3GPP TS 44.018.) Each bit in the 16 bits corresponds to a permitted access class 632 as shown below in Table 4. (See also 3GPP TS 44.018, section 10.5.2.29.)

TABLE 4

| 8 | 7 | 6 | 5 | 4 | 3 | 2 | 1 |
|---|---|---|---|---|---|---|---|
| ACC | ACC | ACC | ACC | ACC | ACC | ACC | ACC |
| 15 | 14 | 13 | 12 | 11 | 10 | 09 | 08 |
| ACC | ACC | ACC | ACC | ACC | ACC | ACC | ACC |
| 07 | 06 | 05 | 04 | 03 | 02 | 01 | 00 |

In Table 4, the access class code (ACC) 650 may be an information element that indicates access barring information. In the defined access class code (ACC) 650, access classes 0-9 are normal classes and access classes 11-15 are defined as special classes. Access class 11 is for public land mobile network (PLMN) use. Access class 12 is for security services. Access class 13 is for public utilities. Access class 14 is for emergency services. Access class 15 is for PLMN staff.

In one configuration, access class 11 and access class 15 may be treated the same. In other words, if one of access class 11 or access class 15 is barred, then both may be barred. In this manner, a single bit may be used for both access class 11 and 15. Thus, an extra bit per segment of PLMN information 644, or 4 bits per system information (SI) message 636 may be saved.

Access class 10 defines which devices may make emergency calls. For example, access class 10 may specify that all access classes (i.e., 0-9 and 11-15) may make emergency calls or that only special classes (11-15) may make emergency calls. Thus, the permitted access class 632 may specify which access classes may make emergency calls with a single bit. If the wireless communication system 100 wishes to prevent wireless communication devices 104 from accessing all 15 classes, then the mobile country code (MCC) 646 and/or the mobile network code (MNC) 648 may be set to FFF. In this manner, the PLMN information 644 in the system information (SI) message 636 may be ignored when received by the wireless communication device 104 and the wireless communication device 104 will not have access to the PLMN.

With the new coding of the PLMN ID 630 and permitted access classes 632 according to embodiments of the present invention, a total of 36 bits are used. This leaves only 4 bits for the network color code (NCC) 652 field for each segment of PLMN information 644 if each segment of PLMN information 644 is limited to 40 bits.

Under known approaches, the network color code (NCC) 652 is 8 bits in length. The network color code (NCC) 652 may include eight base station identity codes (BSICs) as defined in 44.018. In other words, the network color code (NCC) 652 permitted field may be a bit-map indicating if a particular base station identity code (BSIC) value is permitted for cell reselection or not. For example, the base station identity code (BSIC) may have a value of 0, 1, 2, 3, 4, 5, 6, or 7.

Restricting the network color code (NCC) 652 field to 4 bits results in each segment of additional PLMN information 644 being able only to identify four base station identity codes (BSICs) rather than all eight base station identity codes (BSICs). For example, if only four base station identity codes (BSICs) are sent in the network color code (NCC) 652 field, then the wireless communication device 104 would need to obtain the four remaining base station identity codes (BSIC) from another source, such as the primary core network 116. System information (SI) corresponding to the primary core network 116 may have been sent to the wireless communication device 104 as a system information (SI) type 3 message prior to the wireless communication device receiving the new system information (SI) message 636. Thus, the wireless communication device 104 may be able to inherit unsent base station identity codes (BSICs) from the primary PLMN. In many cases, portions of the base station identity codes (BSICs) in the primary PLMN are redundant with corresponding portions in the additional PLMN information 644.

Because the network color code (NCC) 652 may utilize only 4 bits rather than the 8 bits previously used for the network color code (NCC) 652, 4 bits remain. In one configuration, the remaining 4 bits may be inherited from the primary network color code (NCC) field (not shown) sent previously by the access network 108 in a system information (SI) type 3 message. Eight base station identity code (BSIC) values are sent in the primary PLMN broadcast in a system information (SI) type 3 message. In some instances, many of the base station identity codes (BSICs) in the primary PLMN are redundant with corresponding base station identity codes (BSICs) in the additional PLMN information 644. Thus, each segment of PLMN information 644a-d in the system information (SI) message 636 may utilize a subset of known bits of the eight base station identity code (BSIC) values of the primary PLMN.

Under one approach, the four bits sent in each segment of additional PLMN information 644 may correspond to the first or the last 4 bits of the primary network color code (NCC) field. For example, the base station identity code (BSIC) set sent in the system information (SI) message 636 could include values 0, 1, 2, and 3, while the base station identity code (BSIC) values 4, 5, 6, and 7 could be inherited from the primary PLMN. As another example, the base station identity code (BSIC) set sent in the system information (SI) message 636 could include values 4, 5, 6, and 7, while the base station identity code (BSIC) values 0, 1, 2, and 3, could be inherited from the primary PLMN. It should be appreciated that the four base station identity code (B SIC) values that are to be sent over in the system information (SI) message 636 and the four the base station identity code (BSIC) values that are to be inherited from the primary PLMN may vary.

In another configuration, a skip indicator 640 may assist in indicating base station identity code (BSIC) values. The skip indicator 640 is located in the header of the system information (SI) message 636 and includes 4 bits. Typically, the skip indicator 640 is set to “0000.” Under present standards, wireless communication devices 104 are programed to ignore an entire system information (SI) message if the skip indicator 640 is set to a value other than “0000.”

As the skip indicator 640 has no specific purpose under current standards, the four bits in the skip indicator 640 may be reused to allow further flexibility in selecting which four base station identity code (BSIC) values to inherit from the primary PLMN. Thus, under embodiments of the present invention, the skip indicator 640 may be used to indicate which set or subset of base station identity code (BSIC) values are sent in the additional PLMN information 644, thus also indicating which base station identity code (BSIC) values to inherit from the primary PLMN.

In one embodiment of the present invention, the skip indicator 640 may be redefined to be a Base Station Identity Code (BSIC) Group. Under this embodiment, each of the four bits may be used in connection with one of the four segments of additional PLMN information 644a-d. In other words, as there are four bits in the BSIC Group, each bit can be used for one of the four segments of PLMN information 644 as follows: bit 1=first PLMN information 644a, bit 2=second PLMN information 644b, bit 3=third PLMN information 644c, and bit 4=fourth PLMN information 644d. Further, each bit may then indicate if the network color code (NCC) field for each corresponding PLMN information 644 represents base station identity codes (BSIC) 0, 1, 2, and 3 or base station identity codes (BSIC) 4, 5, 6, and 7. An example is shown below in Table 5.

TABLE 5

| BSIC | 7 | 6 | 5 | 4 | 3 | 2 | 1 | 0 |
|---|---|---|---|---|---|---|---|---|
| BSIC Group bit = 0; | Yes | Yes | Yes | Yes | No | No | No | No |
| Inherit BSIC Value from Primary | | | | | | | | |
| NCC for the first PLMN | | | | | | | | |
| information 644a? | | | | | | | | |
| BSIC Group bit = 1; | No | No | No | No | Yes | Yes | Yes | Yes |
| Inherit BSIC Value from Primary | | | | | | | | |
| NCC for the first PLMN | | | | | | | | |
| information 644a? | | | | | | | | |

In Table 5, the BSIC Group is either set to 0 or 1. For example, the BSIC Group bit may be the first bit and may correspond to the first PLMN information 644a. If set to 0 (i.e., BSIC Group bit 1=0), then the values corresponding to base station identity codes (BSIC) 4, 5, 6, and 7 (e.g., the most significant bits (MSBs)) may be inherited from the primary network color code (NCC) field. If set to 1 (i.e., BSIC Group bit 1=1), then the values corresponding to base station identity codes (BSIC) 0, 1, 2, and 3 (e.g., the least significant bits (LSBs)) may be inherited from the primary network color code (NCC) field. It should be appreciated that values other than [0-3] or [4-7] may be used. For example, Table 6 below provides a few examples of base station identity code (BSIC) values that may correspond to bits in the BSIC Group.

TABLE 6

| | |
|---|---|
| BSIC Group bit = 0 | BSIC Group bit = 1 |

| BSIC Set | BSIC Set | BSIC Set | BSIC Set |
|---|---|---|---|
| Inherited | Obtained | Inherited | Obtained |
| from Primary | from NCC | from Primary | from NCC |
| NCC | Field | NCC | Field |
| 0, 1, 2, 3 | 4, 5, 6, 7 | 4, 5, 6, 7 | 0, 1, 2, 3 |
| 1, 2, 3, 4 | 0, 5, 6, 7 | 0, 5, 6, 7 | 1, 2, 3, 4 |
| 2, 3, 4, 5 | 0, 1, 6, 7 | 0, 1, 6, 7 | 2, 3, 4, 5 |
| 3, 4, 5, 6 | 0, 1, 2, 7 | 0, 1, 2, 7 | 3, 4, 5, 6 |
| 4, 5, 6, 7 | 0, 1, 2, 3 | 0, 1, 2, 3 | 4, 5, 6, 7 |
| 0, 5, 6, 7 | 1, 2, 3, 4 | 1, 2, 3, 4 | 0, 5, 6, 7 |
| 0, 1, 6, 7 | 2, 3, 4, 5 | 2, 3, 4, 5 | 0, 1, 6, 7 |
| 0, 1, 2, 7 | 3, 4, 5, 6 | 3, 4, 5, 6 | 0, 1, 2, 7 |

In another configuration, rather than redefining the skip indicator 640 in the system information (SI) message 636 header 642 to be a BSIC Group, the skip indicator 640 may be used to indicate an offset to allow for different sets of contiguous base station identity codes (BSICs) to be selected from the eight available codes. By default, the skip indicator 640 is set to 0000 by the network. However, the skip indicator 640 may be set to other values to allow further flexibility in choosing the base station identity code (BSIC) set. In this configuration, the skip indicator 640 may be redefined as a BSIC Offset. Table 7 below illustrates base station identity code (BSIC) sets inherited from the primary network color code (NCC) field based on the BSIC Offset.

TABLE 7

| BSIC Offset | |
|---|---|
| (Skip Indicator) | BSIC Set for PLMNs |
| 0000 | 0, 1, 2, 3 |
| 0001 | 1, 2, 3, 4 |
| 0010 | 2, 3, 4, 5 |
| 0011 | 3, 4, 5, 6 |
| 0100 | 4, 5, 6, 7 |
| 0101 | 0, 5, 6, 7 |
| 0110 | 0, 1, 6, 7 |
| 0111 | 0, 1, 2, 7 |

In another embodiment of the present invention, rather than having eight base station identity code (BSIC) sets, the four bits allocated for the network color code (NCC) 652 field may correspond to four base station identity codes (BSICs). In other words, in this embodiment, four (rather than eight) base station identity code (BSIC) sets are employed.

In yet another alternative embodiment of the present invention, 8 bits may be used for the network color code (NCC) 652 and 12 bits may be used for the access class code (ACC) 650. In other words, the network color code (NCC) 652 remains unchanged from the legacy case and the access class code (ACC) 650 employs 10 bits rather than 16 bits. Table 8 below provides the bits syntax for sharing information for a segment of additional PLMN information 644 on a single access network 108 in this embodiment.

TABLE 8

```
< Sharing PLMN Information > ::=
    < MCC : bit (10) >
    < MNC : bit (10) >
    < ACC : bit (12) >
    < NCC : bit (8) >
    < spare padding > ;
```

In this embodiment, 10 bits may be used to signal the access capability for access classes 0-9 (i.e., 1 bit for each access class). The remaining 2 bits may then be used to control the special classes. For example, if the remaining 2 bits are set to 00, special classes 11, 12, 13, 14, and 15 may be allowed. Also, if the remaining 2 bits are set to 00, emergency calls may be allowed for all classes. If the remaining 2 bits are set to 01, special classes 12, 13, and 14 are allowed, while special classes 11 and 15 are barred. Also, if the remaining 2 bits are set to 01, emergency calls may be allowed for only special classes. If the remaining 2 bits are set to 10, special classes 13 and 14 may be allowed, while special classes 11, 12, and 15 may be barred. Also, if the remaining 2 bits are set to 10, emergency calls may be allowed for only special classes. If the remaining 2 bits are set to 11, special class 14 is allowed, while special classes 11, 12, 13, and 15 are barred. Also, if the remaining 2 bits are set to 11, emergency calls may be allowed for only special classes. It should be appreciated that the special classes corresponding to the remaining 2 bits in this embodiment may be grouped in a number of various combinations.

If all 15 access classes are to be barred, then all the information for the PLMN may be excluded from the system information (SI) message 636. For example, if all 15 access classes are to be barred, then the mobile country code (MCC) 646 and/or the mobile network code (MNC) 648 may be set to FFF.

The Extended Access Information may be carried by a system information (SI) type 21 message. The extended access information, if broadcast, may be for each of the PLMNs listed in the system information (SI) message 636. The order of the extended access information may be the same as that of the valid PLMNs listed in the system information (SI) message 636. An example coding of the extended access information for additional core networks 106 sharing a single access network 108 is illustrated in Table 9 below. Modifications to known syntax are bolded in Table 9.

TABLE 9

```
< SI 21 Rest Octets > ::=
    < SI 21_CHANGE_MARK : bit (2) >
    < SI 21_INDEX : bit (3) >
    < SI 21_COUNT : bit (3) >
    { 0 | 1 -- Primary PLMN EAB information included
            < EAB Authorization Mask: bit (10) >
            < EAB Subcategory : bit (2) > }
    { L | H -- Sharing PLMN1 EAB information included
            < EAB Authorization Mask: bit (10) >
            < EAB Subcategory : bit (2) > }
    { L | H -- Sharing PLMN2 EAB information included
            < EAB Authorization Mask: bit (10) >
            < EAB Subcategory : bit (2) > }
    { L | H -- Sharing PLMN3 EAB information included
            < EAB Authorization Mask: bit (10) >
            < EAB Subcategory : bit (2) > }
    { L | H -- Sharing PLMN4 EAB information included
            < EAB Authorization Mask: bit (10) >
            < EAB Subcategory : bit (2) > }
    < spare padding > ;
```

The system information (SI) message 636 may be sent in the same positions as system information (SI) type 16 and 17 messages. In some configurations, the system information (SI) message 636 may exclusively be broadcast on the broadcast control channel (BCCH) extended. Under some embodiments of the present invention, a wireless communication device 104 may save 940 milliseconds (ms) of waiting and processing time by receiving information regarding all available additional core networks 106 in a single system information (SI) message 636. Table 10, below, illustrates time delay and positions corresponding to various types of system information (SI) messages.

TABLE 10

| SI 16 | SI 17 | | |
|---|---|---|---|
| Broadcast | Broadcast | SI 22 TC | Delay |
| No | No | 2 and 6 | 940 ms |
| No | Yes | 6 | 1.88 sec |
| Yes | No | 2 | 1.88 sec |
| Yes | Yes | Alternately | 1.88 sec |
| | | on 2 and 6 | |

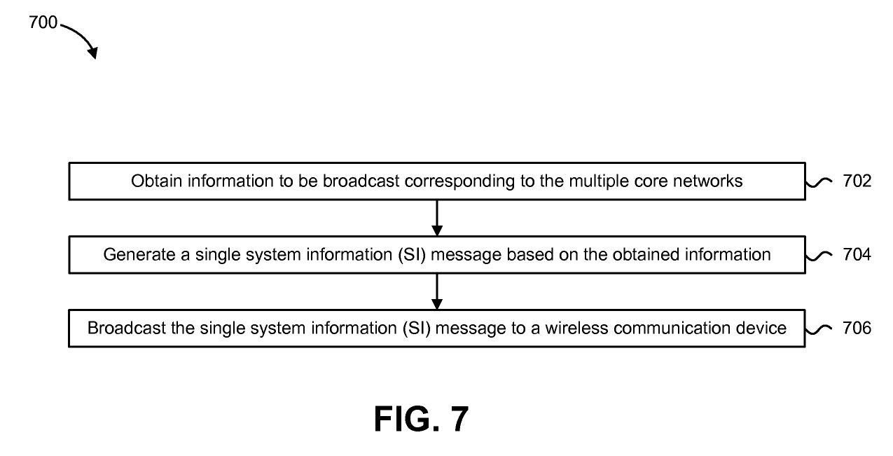

FIG. 7 is a flow diagram of a method 700 for broadcasting additional information related to multiple additional core networks 106 using a single access network 108 according to some embodiments of the present invention. The method 700 may be performed by an access network 108. In some configurations, the access network 108 may include a base station 102 and a system information (SI) broadcast module 110.

The access network 108 may obtain 702 information to be broadcast corresponding to the multiple core networks 106. For example, the access network 108 may receive additional core network information 228 from each of the additional core networks 206.

The access network 108 may generate 704 a single system information (SI) message 436 based on the obtained information. The access network 108 may broadcast 706 the single system information (SI) message 436 to a wireless communication device 104. For example, the base station 102 may broadcast a system information (SI) message 436 to a wireless communication device 104 via a broadcast channel 114.

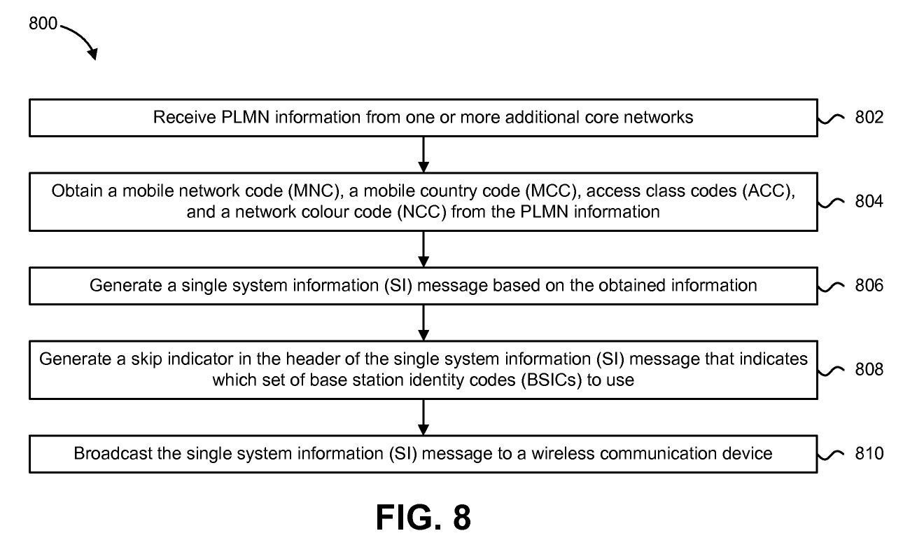

FIG. 8 is a flow diagram of a more detailed method 800 for broadcasting additional information related to multiple additional core networks 106 using a single access network 108 according to some embodiments of the present invention. The method 800 may be performed by a base station 102 within an access network 108. The base station 102 may receive 802 PLMN information 544 from one or more additional core networks 106. The PLMN information 544 may include a PLMN ID 530, permitted access class information 532, and neighbor cell information 534.

The base station 102 may obtain 804 a mobile country code (MCC) 646, a mobile network code (MNC) 648, an access class code (ACC) 650, and a network color code (NCC) 652 from the PLMN information 544. It should be appreciated that other elements in the access network 108 such as the system controller 222 or the gateway 220 may perform one or more steps described in connection with the method 800. In some embodiments, the system controller 222 and/or the gateway 220 may be located within the base station 102. For example, a system controller 222 located within a base station 102 may obtain 804 a mobile country code (MCC) 646, a mobile network code (MNC) 648, an access class code (ACC) 650, and a network color code (NCC) 652 from the core network information 328 received from each additional core network 106.

The base station 102 may generate 806 a single system information (SI) message 436 based on the obtained information. For example, the single system information (SI) message 436 may include a mobile country code (MCC) 646, a mobile network code (MNC) 648, an access class code (ACC) 650, and a network color code (NCC) 652 corresponding to the core network information 328 received from each additional core network 106. The single system information (SI) message 436 may include up to four segments of additional PLMN information 644. The length of each segment of PLMN information 644 in the single system information (SI) message 436 may be 40 bits. For example, the mobile country code (MCC) 646 may be 10 bits, the mobile network code (MNC) 648 may be 10 bits, the access class code (ACC) 650 may be 16 bits, and the network color code (NCC) 652 may be 4 bits.

In another example, the mobile country code (MCC) 646 may be 10 bits, the mobile network code (MNC) 648 may be 10 bits, the access class code (ACC) 650 may be 12 bits, and the network color code (NCC) 652 may be 8 bits. In this example, 10 bits of the access class code (ACC) 650 may represent normal classes and the remaining 2 bits may represent special classes. For example, the remaining 2 bits of the access class code (ACC) 650 may represent the different sets of special classes. In total, the single system information (SI) message 436 may be 160 bits in length.

The base station 102 may generate 808 a skip indicator 640 in the header of the single system information (SI) message 436. The skip indicator 640 may indicate which set of base station identity codes (BSICs) to use. For example, the skip indicator 640 may indicate an offset to apply to a set of four contiguous base station identity codes (BSICs). The skip indicator 640 may be redefined as a BSIC Group or a BSIC Offset as described above and used to specify which set of base station identity codes (BSICs) to inherit from the primary core network 116.

The base station 102 may broadcast 810 the single system information (SI) message 436 to a wireless communication device 104. For example, the base station 102 may broadcast the system information (SI) message 436 to one or more wireless communication device 104a-c on the broadcast channel 114 using the system information (SI) broadcast module 110.

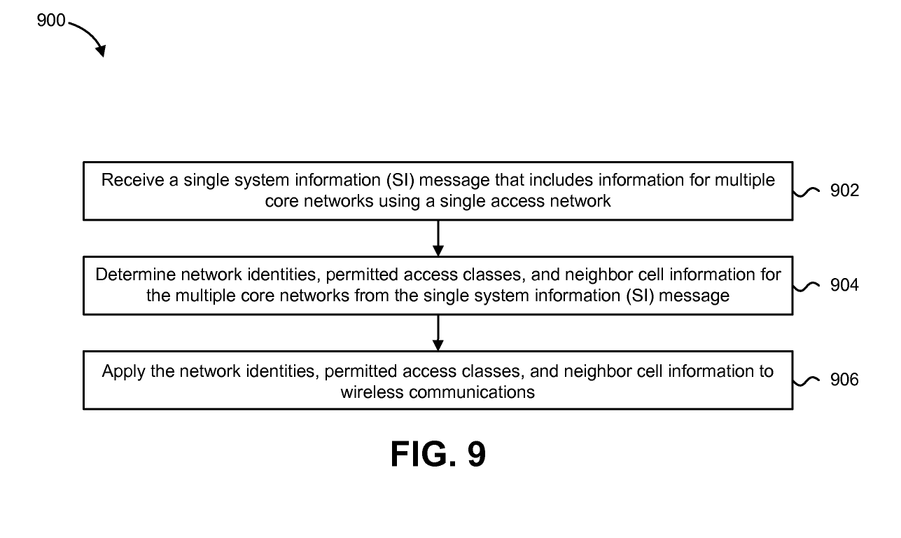

FIG. 9 is a flow diagram of a method 900 for receiving information related to multiple additional core networks 106 using a single access network 108 according to some embodiments of the present invention. The method 900 may be performed by a wireless communication device 104. The wireless communication device 104 may receive 902 a single system information (SI) message 536 that includes information for multiple core networks 106 that use a single access network 108. For example, the single system information (SI) message 536 may have information corresponding to up to four additional PLMNs.

The wireless communication device 104 may determine 904 the network identities (PLMN IDs 530), permitted access class information 532, and neighbor cell information 534 for the multiple additional core networks 106 from the single system information (SI) message 536. In some configurations, wireless communication device 104 may receive an additional system information message, such as a legacy system information message. Here, the wireless communication device 104 may determine 904 a portion of the network identities (PLMN IDs 530), permitted access class information 532, and neighbor cell information 534 for the multiple additional core networks 106 from the single system information (SI) message 536 and determine a portion of the network identities (PLMN IDs 530), permitted access class information 532, and neighbor cell information 534 for the multiple additional core networks 106 from the additional system information message. The wireless communication device 104 may apply 906 the network identities (PLMN IDs 530), permitted access class information 523, and neighbor cell information 534 to wireless communications.

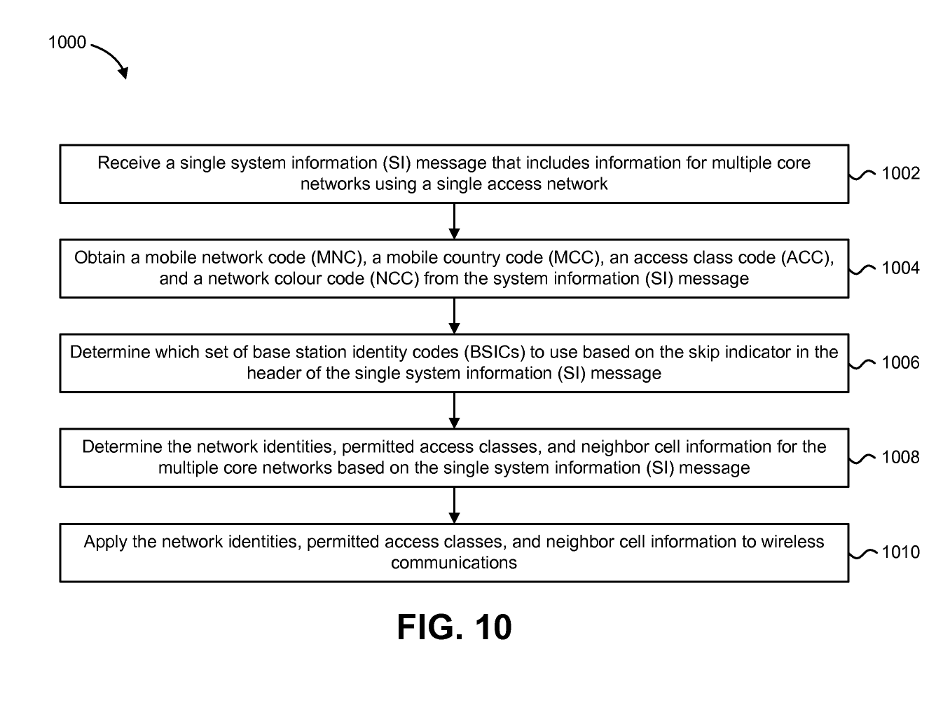

FIG. 10 is a flow diagram of a more detailed method 1000 for receiving information related to multiple additional core networks 106 using a single access network 108 according to some embodiments of the present invention. The method 1000 may be performed by a wireless communication device 104. The wireless communication device 104 may receive 1002 a single system information (SI) message 536 that includes information for multiple core networks 106 that use a single access network 108. For example, the wireless communication device 104 may use the system information (SI) receiver module 112 to receive the single system information (SI) message 536. The single system information (SI) message 536 may be a system information (SI) message 536 having information corresponding to up to four additional PLMNs.

The wireless communication device 104 may obtain 1004 a mobile country code (MCC) 646, a mobile network code (MNC) 648, an access class code (ACC) 650, and a network color code (NCC) 652 from the system information (SI) message 536. The system information (SI) message 536 may include the information corresponding to the additional PLMNs, such as the first PLMN information 644a, the second PLMN information 644b, the third PLMN information 644c, and the fourth PLMN information 644d. Each segment of PLMN information 644 may include a mobile country code (MCC) 646, a mobile network code (MNC) 648, an access class code (ACC) 650, and a network color code (NCC) 652. Thus, the wireless communication device 104 may obtain a mobile country code (MCC) 646, a mobile network code (MNC) 648, an access class code (ACC) 650, and a network color code (NCC) 652 from each segment of additional PLMN information 644.

The wireless communication device 104 may determine 1006 which set of base station identity codes (BSICs) to use based on the skip indicator 640 in the header of the single system information (SI) message 536. For example, the skip indicator 640 may indicate an offset to apply to a set of 4 contiguous base station identity codes (BSICs). The skip indicator 640 may be redefined as a BSIC Group or a BSIC Offset as described above and may specify which set of base station identity codes (BSICs) to inherit from the primary core network 116.

The wireless communication device 104 may determine 1008 the network identities (PLMN IDs 530), permitted access classes (via the permitted access class information 532), and neighbor cell information 534 of the multiple additional core networks 106 based on the single system information (SI) message 536. For example, the wireless communication device 104 may determine the PLMN ID 530 from the mobile network code (MNC) 648 and the mobile country code (MCC) 646, the permitted access classes 632 from the access class code (ACC) 650, and the neighbor cell information 634 from the network color code (NCC) 652 for each PLMN. The wireless communication device 104 may apply 1010 the network identities (PLMN IDs 530), permitted access class information 523, and neighbor cell information 534 to wireless communications.

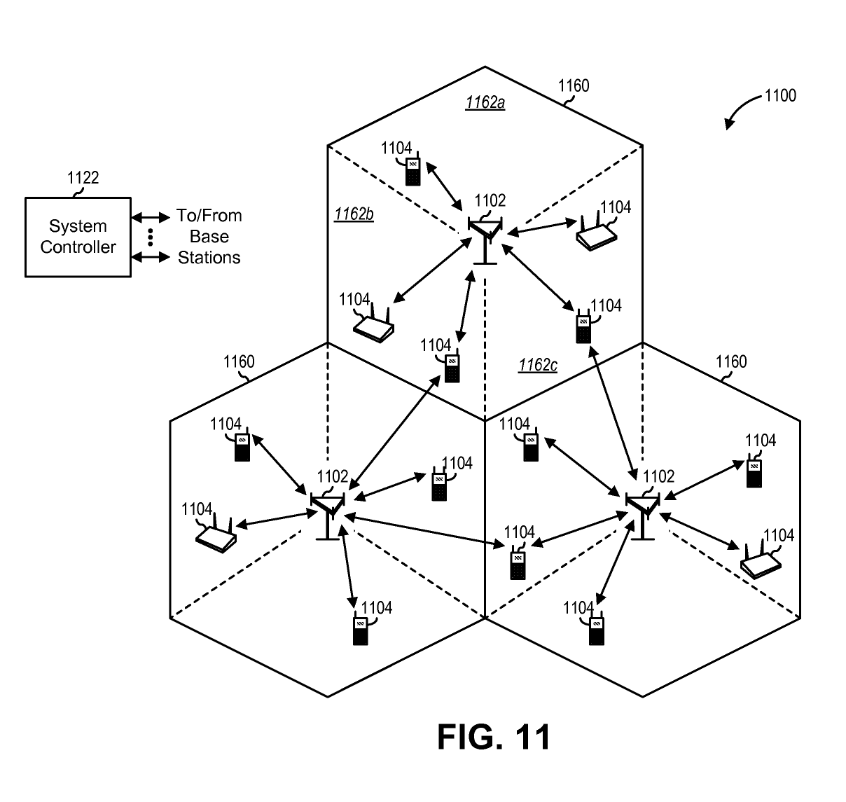

FIG. 11 shows an example of a wireless communication system 1100 in which the systems and methods disclosed herein may be utilized. The wireless communication system 1100 includes multiple base stations 1102 and multiple wireless communication devices 1104. Each base station 1102 provides communication coverage for a particular geographic area 1160. The term “cell” can refer to a base station 1102 and/or its coverage area 1160, depending on the context in which the term is used.

To improve system capacity, a base station coverage area 1160 may be partitioned into plural smaller areas, e.g., three smaller areas 1162a, 1162b, and 1162c. Each smaller area 1162a, 1162b, 1162c may be served by a respective base transceiver station (BTS). The term “sector” can refer to a BTS and/or its coverage area 1162, depending on the context in which the term is used. For a sectorized cell, the BTSs for all sectors of that cell are typically co-located within the base station 1102 for the cell.

Wireless communication devices 1104 are typically dispersed throughout the wireless communication system 1100. A wireless communication device 1104 may communicate with one or more base stations 1102 on the downlink and/or uplink at any given moment. The downlink (or forward link) refers to the communication link from a base station 1102 to a wireless communication device 1104, and the uplink (or reverse link) refers to the communication link from a wireless communication device 1104 to a base station 1102. Uplink and downlink may refer to the communication link or to the carriers used for the communication link.

For a centralized architecture, a system controller 1122 may couple to the base stations 1102 and provide coordination and control for the base stations 1102. The system controller 1122 may be a single network entity or a collection of network entities. For a distributed architecture, base stations 1102 may communicate with one another as needed.

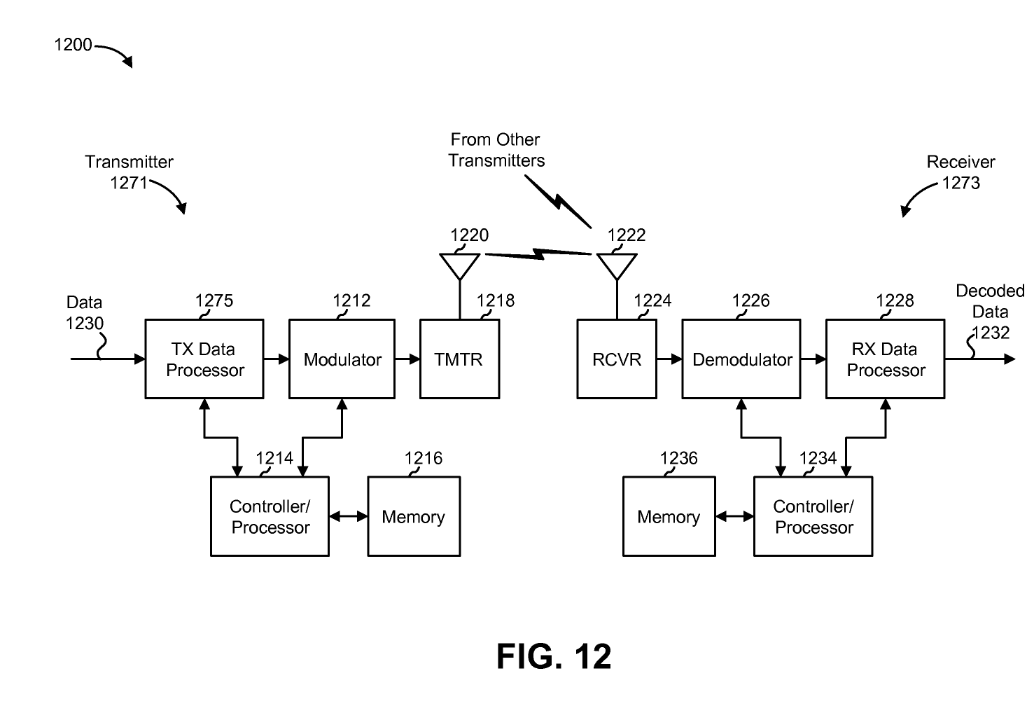

FIG. 12 shows a block diagram of a transmitter 1271 and a receiver 1273 in a wireless communication system 1200. For the downlink, the transmitter 1271 may be part of a base station 102 and the receiver 1273 may be part of a wireless communication device 104. For the uplink, the transmitter 1271 may be part of a wireless communication device 104 and the receiver 1273 may be part of a base station 102.

At the transmitter 1271, a transmit (TX) data processor 1275 receives and processes (e.g., formats, encodes, and interleaves) data 1230 and provides coded data. A modulator 1212 performs modulation on the coded data and provides a modulated signal. The modulator 1212 may perform Gaussian minimum shift keying (GMSK) for GSM, 8-ary phase shift keying (8-PSK) for Enhanced Data rates for Global Evolution (EDGE), etc. GMSK is a continuous phase modulation protocol, whereas 8-PSK is a digital modulation protocol. A transmitter unit (TMTR) 1218 conditions (e.g., filters, amplifies, and upconverts) the modulated signal and generates an RF-modulated signal, which is transmitted via an antenna 1220.

At the receiver 1273, an antenna 1222 receives RF-modulated signals from the transmitter 1271 and other transmitters. The antenna 1222 provides a received RF signal to a receiver unit (RCVR) 1224. The receiver unit 1224 conditions (e.g., filters, amplifies, and downconverts) the received RF signal, digitizes the conditioned signal, and provides samples. A demodulator 1226 processes the samples as described below and provides demodulated data. A receive (RX) data processor 1228 processes (e.g., deinterleaves and decodes) the demodulated data and provides decoded data 1232. In general, the processing by demodulator 1226 and RX data processor 1228 is complementary to the processing by the modulator 1212 and the TX data processor 1275, respectively, at the transmitter 1271.

Controllers/processors 1214 and 1234 direct operation at the transmitter 1271 and receiver 1273, respectively. Memories 1216 and 1236 store program codes in the form of computer software and data used by the transmitter 1271 and receiver 1273, respectively.

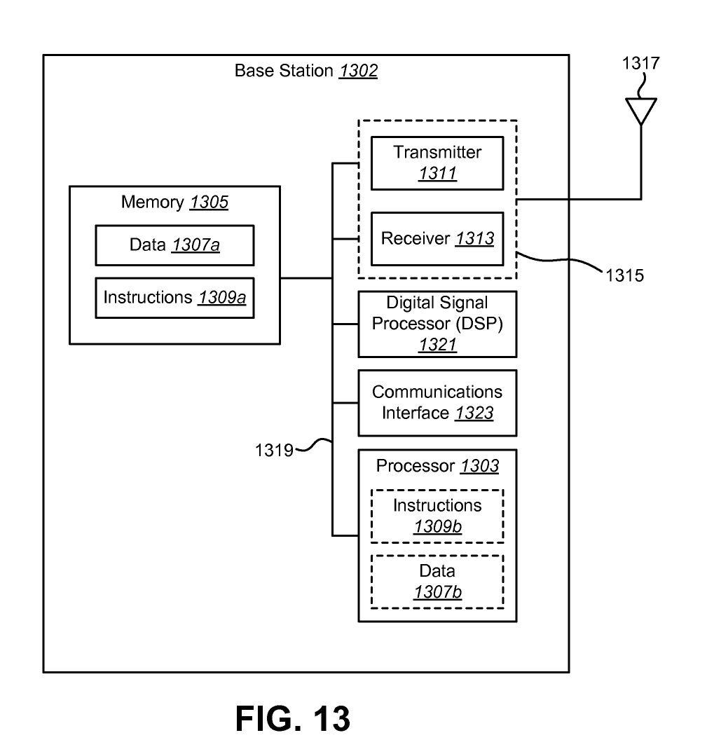

FIG. 13 illustrates certain components that may be included within a base station 1302 according to some embodiments of the present invention. A base station 1302 may also be referred to as, and may include some or all of the functionality of, an access point, a broadcast transmitter, a NodeB, an evolved NodeB, etc. The base station 1302 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the base station 1302 of FIG. 13, in an alternative configuration, a combination of processors (e.g., an ARM and DSP) could be used.

The base station 1302 also includes memory 1305. The memory 1305 may be any electronic component capable of storing electronic information. The memory 1305 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1307a and instructions 1309a may be stored in the memory 1305. The instructions 1309a may be executable by the processor 1303 to implement the methods disclosed herein. Executing the instructions 1309a may involve the use of the data 1307a that is stored in the memory 1305. When the processor 1303 executes the instructions 1309a, various portions of the instructions 1309b may be loaded onto the processor 1303, and various pieces of data 1307b may be loaded onto the processor 1303.

The base station 1302 may also include a transmitter 1311 and a receiver 1313 to allow transmission and reception of signals to and from the base station 1302. The transmitter 1311 and receiver 1313 may be collectively referred to as a transceiver 1315. An antenna 1317 may be electrically coupled to the transceiver 1315. The base station 1302 may also include (not shown) multiple transmitters, multiple receivers, multiple transceivers and/or additional antennas.

The base station 1302 may include a digital signal processor (DSP) 1321. The base station 1302 may also include a communications interface 1323. The communications interface 1323 may allow a user to interact with the base station 1302.

The various components of the base station 1302 may be coupled together by one or more buses, which may include a power bus, a control signal bus, a status signal bus, a data bus, etc. For the sake of clarity, the various buses are illustrated in FIG. 13 as a bus system 1319.

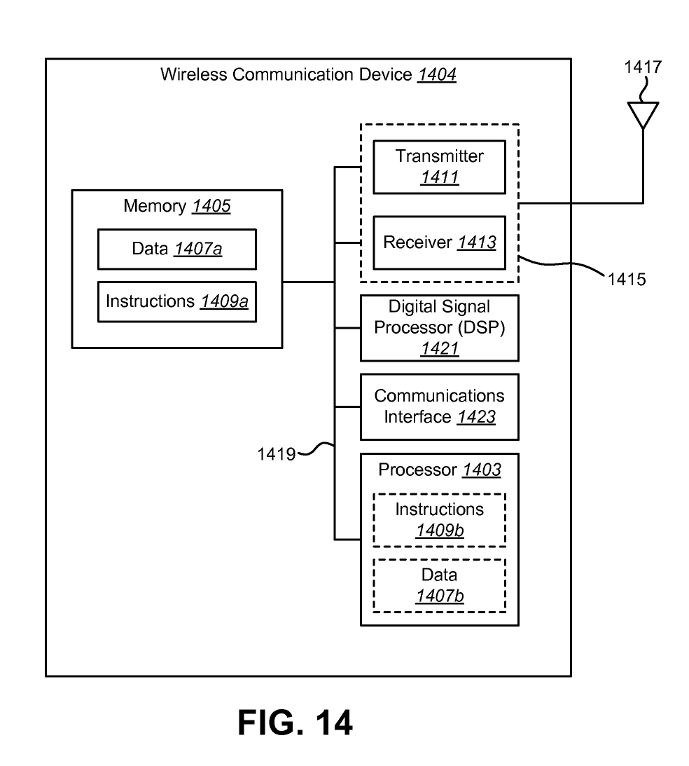

FIG. 14 illustrates certain components that may be included within a wireless communication device 1404 according to some embodiments of the present invention. The wireless communication device 1404 may be an access terminal, a mobile station, a user equipment (UE), etc. The wireless communication device 1404 includes a processor 1403. The processor 1403 may be a general purpose single- or multi-chip microprocessor (e.g., an ARM), a special purpose microprocessor (e.g., a digital signal processor (DSP)), a microcontroller, a programmable gate array, etc. The processor 1403 may be referred to as a central processing unit (CPU). Although just a single processor 1403 is shown in the wireless communication device 1404 of FIG. 14, in an alternative configuration, a combination of processors (e.g., an ARM and DSP) could be used.

The wireless communication device 1404 also includes memory 1405. The memory 1405 may be any electronic component capable of storing electronic information. The memory 1405 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1407a and instructions 1409a may be stored in the memory 1405. The instructions 1409a may be executable by the processor 1403 to implement the methods disclosed herein. Executing the instructions 1409a may involve the use of the data 1407a that is stored in the memory 1405. When the processor 1403 executes the instructions 1409, various portions of the instructions 1409b may be loaded onto the processor 1403, and various pieces of data 1407b may be loaded onto the processor 1403.

The wireless communication device 1404 may also include a transmitter 1411 and a receiver 1413 to allow transmission and reception of signals to and from the wireless communication device 1404 via an antenna 1417. The transmitter 1411 and receiver 1413 may be collectively referred to as a transceiver 1415. The wireless communication device 1404 may also include (not shown) multiple transmitters, multiple antennas, multiple receivers, and/or multiple transceivers.

The wireless communication device 1404 may include a digital signal processor (DSP) 1421. The wireless communication device 1404 may also include a communications interface 1423. The communications interface 1423 may allow a user to interact with the wireless communication device 1404.

The various components of the wireless communication device 1404 may be coupled together by one or more buses, which may include a power bus, a control signal bus, a status signal bus, a data bus, etc. For the sake of clarity, the various buses are illustrated in FIG. 14 as a bus system 1419.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the figures. Where a term is used without a reference number, this is meant to refer generally to the term without limitation to any particular figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 7-10, can be downloaded, and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the systems, methods, and apparatus described herein without departing from the scope of the claims.

We claim:

1. A method for broadcasting information related to multiple core networks that use a single access network, the method comprising:
obtaining information to be broadcast corresponding to the multiple core networks;
generating a single system information message based on the obtained information; and
broadcasting the single system information message to a wireless communication device.

2. The method of claim 1, wherein the method is performed by a base station.

3. The method of claim 1, wherein the obtained information corresponds to a public land mobile network, and wherein the obtained information comprises a mobile network code, a mobile country code, an access class code, and a network color code.

4. The method of claim 3, wherein the length of the mobile country code field is 10 bits, and wherein the length of the mobile network code field is 10 bits.

5. The method of claim 4, wherein the mobile country code field is coded as a binary value of the mobile country code, and wherein the mobile network code field is coded as a binary value of the mobile network code.

6. The method of claim 3, wherein the length of the access class code field is 12 bits.

7. The method of claim 6, wherein 10 bits of the access class code represents normal classes.

8. The method of claim 6, wherein 2 bits of the access class code represents special classes.

9. The method of claim 8, wherein the value of the 2 bits of the access class code represents different set of special classes.

10. The method of claim 3, wherein the length of the network color code field is 4 bits.

11. The method of claim 3, wherein network color code information is transmitted for only four base station identity codes.

12. The method of claim 11, wherein a skip indicator is used to indicate which set of four base station identity codes is used.

13. The method of claim 12, wherein the skip indicator indicates an offset applied to the set of four base station identity codes.

14. The method of claim 11, wherein the set of four base station identity codes is a set of four contiguous base station identity codes.

15. A method for receiving information related to multiple core networks that use a single access network, the method comprising:
receiving a single system information message that comprises information for multiple core networks that use the single access network;
determining network identities, permitted access classes, and neighbor cell information for the multiple core networks from the single system information message; and
applying the network identities, permitted access classes, and neighbor cell information to wireless communications.

16. The method of claim 15, wherein the method is performed by a wireless communication device.

17. The method of claim 15, wherein the obtained information corresponds to a public land mobile network, and wherein the obtained information comprises a mobile network code, a mobile country code, an access class code, and a network color code.

18. The method of claim 17, wherein the length of the mobile country code field is 10 bits, and wherein the length of the mobile network code field is 10 bits.

19. The method of claim 17, wherein the mobile country code field is coded as a binary value of the mobile country code, and wherein the mobile network code field is coded as a binary value of the mobile network code.

20. The method of claim 17, wherein the length of the access class code field is 12 bits.

21. The method of claim 20, wherein 10 bits of the access class code represents normal classes.

22. The method of claim 20, wherein 2 bits of the access class code represents special classes.

23. The method of claim 22, wherein the value of the 2 bits of the access class code represents different set of special classes.

24. The method of claim 17, wherein the length of the network color code field is 4 bits.

25. The method of claim 17, wherein network color code information is transmitted for only four base station identity codes.

26. The method of claim 25, wherein a skip indicator is used to indicate which set of four base station identity codes is used.

27. The method of claim 26, wherein the skip indicator indicates an offset applied to the set of four base station identity codes.

28. The method of claim 25, wherein the set of four base station identity codes is a set of four contiguous base station identity codes.

29. The method of claim 15, further comprising receiving an additional system information message, and wherein a portion of the network identities, the permitted access classes, and the neighbor cell information for the multiple core networks is determined from the single system information message and a portion of the network identities, the permitted access classes, and the neighbor cell information for the multiple core networks is determined from the additional system information message.

30. The method of claim 29, wherein the single system information message is a new system information message, and wherein the system information message is a legacy system information message.

31. The method of claim 15, wherein the single system information message comprises information corresponding to four multiple core networks.

32. An apparatus for broadcasting information related to multiple core networks that use a single access network, comprising:
a processor;
memory in electronic communication with the processor; and
instructions stored in the memory, the instructions being executable by the processor to:
obtain information to be broadcast corresponding to the multiple core networks;
generate a single system information message based on the obtained information; and
broadcast the single system information message to a wireless communication device.

33. The apparatus of claim 32, wherein the apparatus is a base station.

34. The apparatus of claim 32, wherein the obtained information corresponds to a public land mobile network, and wherein the obtained information comprises a mobile network code, a mobile country code, an access class code, and a network color code.

35. The apparatus of claim 34, wherein the length of the mobile country code field is 10 bits, and wherein the length of the mobile network code field is 10 bits.

36. The apparatus of claim 34, wherein the length of the access class code field is 12 bits.

37. The apparatus of claim 34, wherein the length of the network color code field is 4 bits.

38. An apparatus for receiving information related to multiple core networks that use a single access network, comprising:
a processor;
memory in electronic communication with the processor; and
instructions stored in the memory, the instructions being executable by the processor to:
receive a single system information message that comprises information for multiple core networks that use the single access network;
determine network identities, permitted access classes, and neighbor cell information for the multiple core networks from the single system information message; and
apply the network identities, permitted access classes, and neighbor cell information to wireless communications.

39. The apparatus of claim 38, wherein the apparatus is a wireless communication device.

40. The apparatus of claim 38, wherein the obtained information corresponds to a public land mobile network, and wherein the obtained information comprises a mobile network code, a mobile country code, an access class code, and a network color code.

41. The apparatus of claim 40, wherein the length of the mobile country code field is 10 bits, and wherein the length of the mobile network code field is 10 bits.

42. The apparatus of claim 40, wherein the length of the access class code field is 12 bits.

43. The apparatus of claim 40, wherein the length of the network color code field is 4 bits.

44. A computer-program product for broadcasting information related to multiple core networks that use a single access network, the computer-program product comprising a non-transitory computer-readable medium having instructions thereon, the instructions comprising:
code for causing a base station to obtain information to be broadcast corresponding to the multiple core networks;
code for causing the base station to generate a single system information message based on the obtained information; and
code for causing the base station to broadcast the single system information message to a wireless communication device.

45. The computer-program product of claim 44, wherein the obtained information corresponds to a public land mobile network, and wherein the obtained information comprises a mobile network code, a mobile country code, an access class code, and a network color code.

46. The computer-program product of claim 45, wherein the length of the mobile country code field is 10 bits, and wherein the length of the mobile network code field is 10 bits.

47. The computer-program product of claim 45, wherein the length of the access class code field is 12 bits.

48. The computer-program product of claim 45, wherein the length of the network color code field is 4 bits.

49. A computer-program product for receiving information related to multiple core networks that use a single access network, the computer-program product comprising a non-transitory computer-readable medium having instructions thereon, the instructions comprising:
code for causing a wireless communication device to receive a single system information message that comprises information for multiple core networks that use the single access network;
code for causing the wireless communication device to determine network identities, permitted access classes, and neighbor cell information for the multiple core networks from the single system information message; and
code for causing the wireless communication device to apply the network identities, permitted access classes, and neighbor cell information to wireless communications.

50. The computer-program product of claim 49, wherein the obtained information corresponds to a public land mobile network, and wherein the obtained information comprises a mobile network code, a mobile country code, an access class code, and a network color code.

51. The computer-program product of claim 50, wherein the length of the mobile country code field is 10 bits, and wherein the length of the mobile network code field is 10 bits.

52. The computer-program product of claim 50, wherein the length of the access class code field is 12 bits.

53. The computer-program product of claim 50, wherein the length of the network color code field is 4 bits.
